(19) United States
(12) Patent Application Publication
(10) Pub. No.: US 2010/0188219 A1
(43) Pub. Date: Jul. 29, 2010

(54) SECURITY MODULE

(76) Inventor: Robert Edmund Todd, Cramlington (GB)

Correspondence Address: Zilka-Kotab, PC, P.O. BOX 721120, SAN JOSE, CA, 95172-1120, US

(21) Appl. No.: 12/445,151

(22) PCT Filed: Oct. 9, 2007
(86) PCT No.: PCT/GB07/03816

§ 371 Date: Apr. 15, 2010

(51) Int. Cl. G08B 13/14

(52) U.S. Cl. 340/568.1

(57) ABSTRACT

A security module (2) comprises a motion detector (4), a microcontroller (6) and an antenna (8). The motion detector (4) detects motion of the security module relative to a cellular telephone network. The security module (2) is adapted to be installed into the cash cassette of an ATM (Automatic Telling Machine) or any container in which valuable goods are stored. A tracking module (10) comprises a microcontroller (12) and an antenna (14) for receiving and transmitting radio frequency signals. The tracking module (10) enables a user to home in on the security module (2) via an exchange of radio frequency-signals.

The present invention relates to a security module for a cash container of an ATM (automatic telling machine), and relates particularly, but not exclusively, to a method of tracking a security module for a cash container of an ATM.

Automatic telling machines (ATM's) and vending machines located in areas where there is little security can be vulnerable to attack. For example, an ATM can be completely removed by destroying the fixtures to which the ATM is attached, or the cash container can be removed by gaining unauthorised access to the ATM.

It is therefore desirable to provide a method and apparatus for tracking an ATM or a vending machine, or the contents of an ATM or vending machine that has been stolen.

According to an aspect of the present invention, there is provided a security module comprising:

motion detector means adapted to detect motion of the security module relative to a cellular telephone network including a plurality of transceivers;

transmitter means for transmitting an alarm signal at a first duty cycle in response to detection by the motion detector means of motion of the security module relative to the cellular telephone network;

receiver means for receiving an acknowledgement signal transmitted by a tracking module; and

control means adapted to cause said transmitter means to transmit said alarm signal at a second duty cycle, greater than said first duty cycle, in response to receipt of said acknowledgement signal by the receiver means.

By providing motion detector means adapted to detect motion of to security module relative to a cellular telephone network, this provides the advantage that the cellular telephone network can be used as a motion sensor to determine an approximate geographical location of the security module. It is undesirable to use a GPS (Global Positioning Satellite) system for such a task because the signals from the satellites on which GPS depends are very low powered. These signals can be blocked by cloud cover, trees, tall buildings and other physical obstacles. For example, to prevent a security module from receiving signals from a GPS satellite it is possible to put the tracked item (for example an ATM)in a motor vehicle such as a van and the signal will be blocked by the van.

By providing a transmitter means for transmitting an alarm signal at a first duty cycle and control means adapted to cause the transmitter means to transmit the alarm signal at a second duty cycle greater than said first duty cycle in response to receipt of an acknowledgement signal by the receiver means, this provides the advantage of improving the battery life of the device. As a result of the improvement to the battery life, the physical dimensions of the device can be reduced to make the device easier to conceal.

By providing a low initial duty cycle at which the alarm signal is transmitted, this provides the advantage of making the device harder to locate electronically with a frequency scanner. Also, the combination of using a cellular telephone network and a transmitter means to assist in locating the security module provides the advantage that a cellular telephone network can be used to provide an approximate indication of the location of the security module and then the transmitter means can be used to home in on the security module.

In a preferred embodiment, the control means is adapted to increase the duty cycle at which the alarm signal is transmitted in response to a further acknowledgement signal transmitted by said tracking module, said further acknowledgement signal indicating increased proximity between the security module and the tracking module.

This provides the advantage of assisting location of the security module by a tracking module because the frequency at which the alarm signal is transmitted is increased as the tracking module nears the security module.

In a preferred embodiment, the alarm signal is transmitted at a first plurality of power levels in response to detecting by the motion detector means of motion of the security module relative to the cellular telephone network; and

the control means is adapted to cause said transmitter means to re-transmit said alarm signal at a second plurality of power levels comprising the lowest of said first plurality of power levels at which the alarm signal was received by said tracking module and at least one lower power level of the first plurality of power levels in response to receipt of said acknowledgement signal by the receiver means.

By transmitting an alarm signal at a first plurality of power levels in response to detection of motion, this provides the advantage that the lowest power level at which a tracking module receives the alarm signal gives an indication of the proximity of the security module to the tracking module.

By re-transmitting the alarm signal at a second plurality of power levels comprising the lowest of the first plurality of power levels at which the alarm signal was received by the tracking module and at least one lower power level, this provides the advantage that since all higher power levels are excluded the battery power of the transmitter means is preserved. This also provides the advantage of allowing the physical dimensions of the security module to be reduced.

In a preferred embodiment, the control means is adapted to change the plurality of power levels at which the alarm signal is transmitted in response to receipt of further acknowledgement signals by the receiver means to indicate the proximity of said tracking module to the security module.

By changing the plurality of power levels at which the alarm signal is transmitted in response to receipt of acknowledgement signals by receiver means, this provides the advantage of indicating the proximity of the tracking module to the security module in a dynamic manner since the transmitted power levels are continually adapted until such time as the lowest power level is being transmitted to indicate close proximity of the tracking module to the security module.

Said alarm signal may be transmitted more frequently at lower power levels than higher power levels.

This provides the advantage of further preserving battery power.

According to another aspect of the present invention, there is provided a security assembly comprising:

a tracking module for receiving an alarm signal transmitted by a security module and transmitting an acknowledgement signal in response to receipt of the alarm signal; and

a security module as defined above.

In a preferred embodiment, said acknowledgement signal indicates the lowest of a first plurality of power levels which the alarm signal was received by said tracking module.

According to another aspect of the present invention, there is provided a method of tracking a security module comprising:

transmitting an alarm signal at a first duty cycle by a security module in response to detection of motion of the security module relative to a cellular telephone network;

receiving an acknowledgement signal transmitted by a tracking module at the security module; and

causing the security module to transmit said alarm signal on a second duty cycle, greater than said first duty cycle, in response to receipt of said acknowledgement signal at the security module.

By detecting motion of the security module relative to a cellular telephone network, this provides the advantage that the cellular telephone network can be used as a motion sensor to determine an approximate geographical location of the security module. It is undesirable to use a GPS (Global Positioning Satellite) system for such a task because the signals from the satellites on which GPS depends are very low powered. These signals can be blocked by cloud cover, trees, tall buildings and other physical obstacles. For example, to prevent a security module from receiving signals from a GPS satellite it is possible to put the tracked item (for example an ATM)in a motor vehicle such as a van and the signal will be blocked by the van.

By transmitting an alarm signal at a first duty cycle and causing the transmitter means to transmit the alarm signal at a second duty cycle, greater than said first duty cycle, in response to receipt of an acknowledgement signal, this provides the advantage of improving the battery life of the device. As a result of the fact that the battery life is improved, this means that the physical dimensions of the device can be reduced to make the device easier to conceal.

By providing a low initial duty cycle at which the alarm signal is transmitted, this provides the advantage of making the device harder to locate electronically with a frequency scanner. Also, the combination of using a cellular telephone network and a transmitter to assist in locating the security module provides the advantage that a cellular telephone network can be used to provide an approximate indication of the location of the security module, and then the transmitter means can be used to home in on the security module.

In a preferred embodiment, the method further comprises increasing the duty cycle at which the alarm signal is transmitted in response to receipt of further acknowledgement signals at the security module, said further acknowledgement signals indicating increased proximity between the security module and a tracking module.

This provides the advantage of assisting location of the security module by a tracking module because the frequency at which the alarm signal is transmitted is increased as the tracking module nears the security module.

In a preferred embodiment, the alarm signal is transmitted at a first plurality of power levels in response to detection of motion of the security module relative to the cellular telephone network; and

said transmitter means re-transmits said alarm signal at a second plurality of power levels comprising the lowest of said first plurality of power levels at which the alarm signal was received by said tracking module and at least one lower power level of the first plurality of power levels in response to receipt of said acknowledgement signal by the security module.

By transmitting an alarm signal at a first plurality of power levels in response to detection of motion, this provides the advantage that the lowest power level at which a tracking module receives the alarm signal gives an indication of the proximity of the security module to the tracking module.

By re-transmitting the alarm signal at a second plurality of power levels comprising the lowest of the first plurality of power levels at which the alarm signal was received by the tracking module and at least one lower power level, this provides the advantage that since all higher power levels are excluded the battery power of the transmitter means is preserved. This also provides the advantage of allowing the physical dimensions of the security module to be reduced.

The method may further comprise changing the plurality of power levels at which the alarm signal is transmitted in response to receipt of further acknowledgement signals by the receiver means to indicate the proximity of said tracking module to the security module.

By changing the plurality of power levels at which the alarm signal is transmitted in response to receipt of acknowledgement signals by receiver means, this provides the advantage of indicating the proximity of the tracking module to the security module in a dynamic manner since the transmitted power levels are continually adapted until such time as the lowest power level is being transmitted to indicate close proximity of the tracking module to the security module.

Said alarm signal may be transmitted more frequently at lower power levels than at higher power levels.

This provides the advantage of further preserving battery power.

A preferred embodiment of the present invention will now be described, by way of example only and not in any limitative sense, with reference to the accompanying drawings in which:

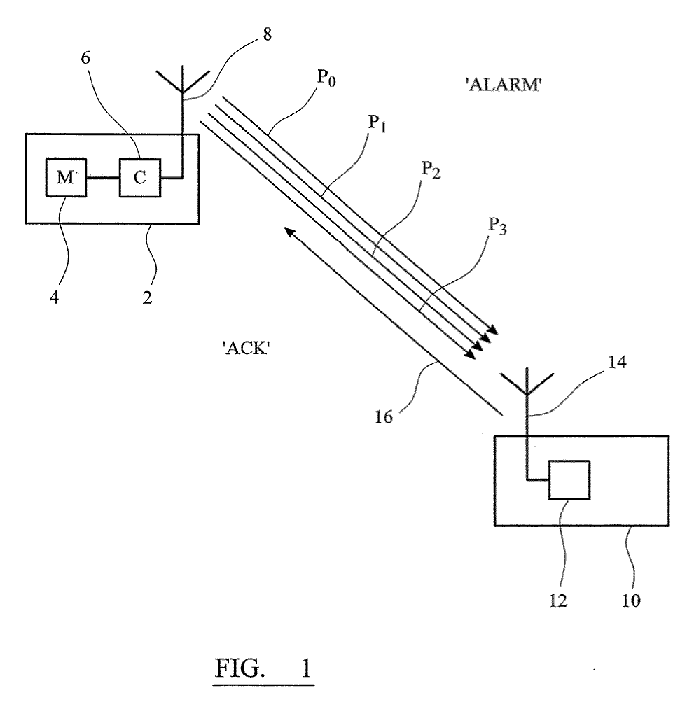

FIG. 1 is a schematic view of a cash container tracking system comprising a security module and a tracking module;

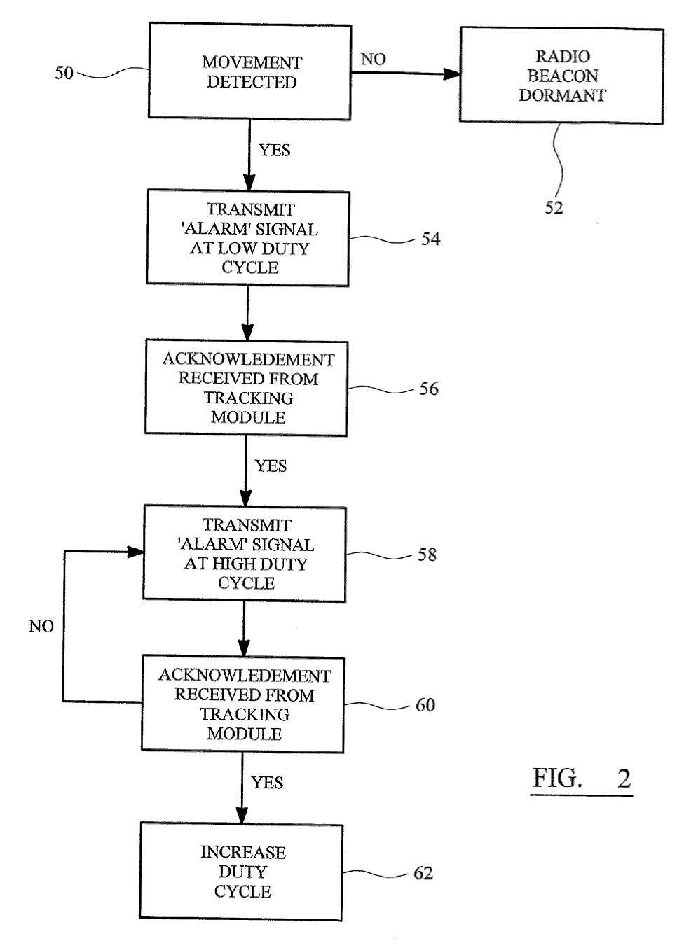

FIG. 2 is a flow chart of the steps taken by the controller of the security module during removing and tracking of the security module to alter the duty cycle at which an alarm signal is transmitted; and

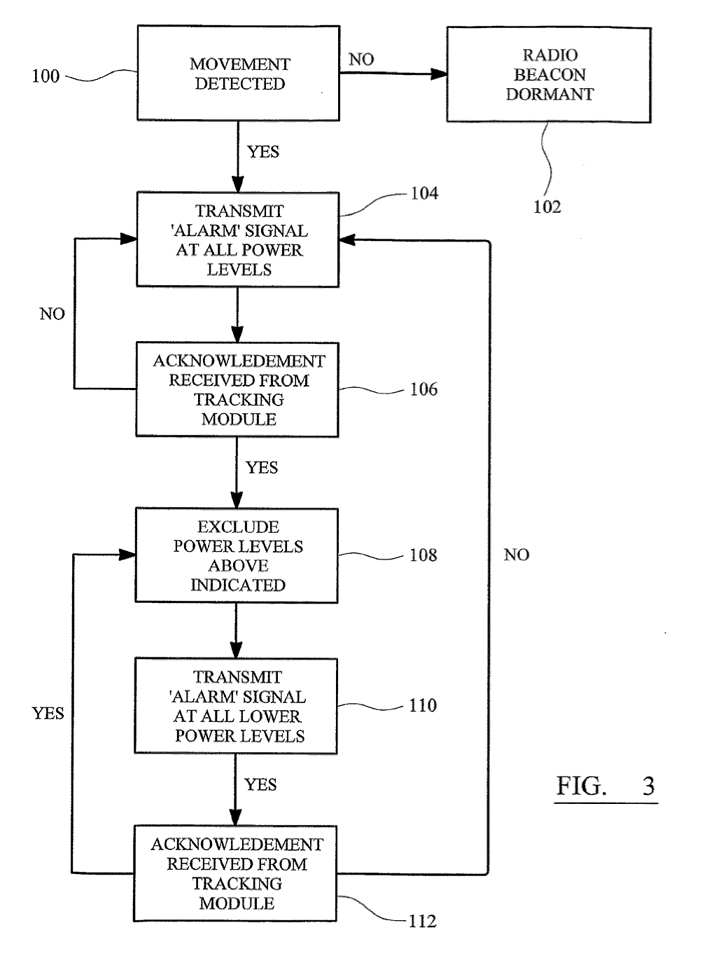

FIG. 3 is a flow chart of the steps taken by the controller of the security module during removal and tracking of the security module to alter the power level at which the alarm signal is transmitted.

Referring to FIG. 1, a security module 2 comprises a motion detector 4, a microcontroller 6 and an antenna 8. The security module 2 is adapted to be installed into the cash cassette of an ATM (Automatic Telling Machine), or any container in which valuable goods are stored.

The motion detector module 4 is adapted to detect motion of the security module relative to a cellular telephone network, such as a GPRS or GSM network. This is accomplished by detecting passage of the security module 2 through the various cells of the cellular telephone network. The motion detector 4 may also comprise a secondary motion detector such as a tilt switch, accelerometer or acoustic sensor, or other device that can provide an output confirming that the security module is moving. A smoke and/or heat detector (not shown) can be disposed in the security module 2 to detect grinding or oxyacetylene attacks.

The motion detector 4 and microcontroller 6 also comprise switching means (not shown) to enable an authorised person to deactivate the security module for the purpose of refilling the cash container. The switching may be accomplished from a central control room via a cell phone link, or could be accomplished with a dedicated key fob.

Microcontroller 6 is adapted to transmit and receive radio frequency signals via antenna 8.

A tracking module 10 comprises a microcontroller 12 and an antenna 14 for receiving and transmitting radio frequency signals. The tracking module 10 may be a battery powered portable device and enables a user to home in on the security module 2 via an exchange of radio frequency signals as will be described in more detail below. The tracking module is adapted to provide an audible and/or visual indication to a user of the proximity between the tracking module 10 and the security module 2.

When motion detector 4 detects motion of the security module 2 by detecting the security module 2 moving relative to the cells of a cellular telephone network, such as a GPRS or a GSM network, a signal is sent from motion detector 4 to microcontroller 6. An alarm signal is then transmitted from antenna 8 at a low duty cycle (where the duty cycle is defined as the ratio of on time to off time) such as 60:1, i.e. transmitting the alarm signal for one second during every minute. The alarm signal comprises the same signal transmitted at several different power levels indicated by P₀ to P₃ in FIG. 1, wherein the power level of the alarm signal rises incrementally from P₀ to P₃. More or less power levels other than the four discrete levels described can be used.

Referring to FIG. 2, at step 50, the security module 2 is stationary. So long as the motion detector 4 remains stationary and does not move relative to the cellular telephone network then the radio beacon comprising microcontroller 6 and antenna 8 remains dormant as shown at step 52. When movement is detected by motion detector 4, the antenna 8 is caused to transmit an alarm signal at all power levels P₀ to P₃ at step 54, the transmission being made at a low duty cycle such as 60:1.

If tracking module 10 receives the alarm signal, then an acknowledgement signal 16 is transmitted by the tracking module 10. The alarm signal provides an indication of the approximate geographical location of the security module 2 obtained from the data provided by the cellular telephone network. It will be apparent to the person skilled in the art that in a city this data is accurate to approximately 100 metres, and in more remote areas the accuracy falls to approximately half a kilometre. The approximate geographical location data provided by the alarm signal may be received and interpreted at a central control room. This data can then be used to instruct a user carrying tracking module 10 to proceed to the approximate geographical location. Alternatively, the tracking module 10 may be adapted to interpret the approximate geographical location data carried by the alarm signal to provide an audible and/or visual indication to a user of the approximate geographical location of the security module 2.

When the security module 2 receives the acknowledgement from the tracking module 10 as indicated at step 56, the frequency at which the alarm signal is transmitted is increased to a higher duty cycle as indicated at step 58. For example, the duty cycle may be increased to 10:1. The higher duty cycle makes it easier for the tracking module 10 to locate the security module 2. In order to communicate the proximity of the security module 2 to a user, the tracking module emits an audible and/or visual signal. For example, the tracking module 10 may emit an audible click each time an alarm signal is received, the frequency of the clicks increasing as the duty cycle of the alarm signal increases to indicate increasing proximity. Alternatively, flashing LEDs could be used.

The tracking module 10 could be fitted with a directional antenna (not shown), such that the frequency of audible clicks increases as the antenna is pointed towards the security module 2, and decreases as the directional antenna is pointed away from the security module 2.

At step 60, if the security module 2 receives an acknowledgement signal indicating that the proximity of the security module 2 and tracking module 10 is increasing, the duty cycle may be increased further at step 62, for example to 5:1.

By first transmitting the alarm signal at a low duty cycle such as 60:1, this allows relatively small batteries to be used and improves the battery life by a factor of 60. Also, the relatively small physical dimensions permitted as a result of the power saving means that the dimensions of the security module 2 can be physically small to enable better concealment of the security module 2.

Referring to FIG. 3, a further power saving feature of the security module 2 is described. At step 100 the security module is stationary. So long as the motion detector 4 remains stationary, then the radio beacon comprising microcontroller 6 and antenna 8 remains dormant as shown at step 102. When movement is detected by the motion detector 4, the antenna 8 is caused to transmit an alarm signal at all power levels P₀ to P₃ at step 104.

If after a predetermined period of time and acknowledgement signal is not received from the tracking module 10 as indicated at step 106, then the security module 2 reverts to step 104 until an acknowledgement is received from the tracking module 10.

If the tracking module 10 receives the alarm signal, an acknowledgement signal 16 is transmitted by the tracking module 10. Acknowledgement signal 16 contains information indicating the lowest power level of P₀ to P₃ at which the alarm signal is heard by the tracking module 10. For example, if the alarm signal was heard by the tracking module 10 at power levels P₂ and P₃ only (the two highest power levels) then the acknowledgement signal 16 will be transmitted by the tracking module 10 indicating that the lowest power level at which the tracking module 10 heard the alarm signal was power level P₂.

When the acknowledgement signal 16 indicating the tracking module heard the alarm signal at power level P₂ is received by security module 2, the microcontroller 6 reconfigures the alarm signal at step 108 to retransmit the alarm signal at power levels P₀ to P₂ (and therefore not at P₃). This is because tracking module 10 has been determined to be within a distance from security module 2 at which the greatest power required to communicate between the two modules is P₂. Since P₃ is greater than P₂, it is no longer necessary to transmit at P₃ because the tracking module 10 is within a lower power level range (i.e. P₂) of security module 2.

At step 110, the alarm signal is therefore re-transmitted at power levels P₀ to P₂. As the tracking module 10 moves closer to the security module 2, the process is repeated starting at step 112 where an acknowledgement indicating the lowest power level at which the tracking module 10 received the alarm signal is sent to the security module 2. As the tracking module 10 moves closer to security module 2, there will eventually be a distance reached at which the only power level at which the alarm signal is transmitted is the lowest power level P₀ since the tracking module 10 and security module 2 are within close proximity to one another.

By continually reducing the power levels at which the alarm signal is transmitted, this provides the advantage of reducing the power required by the transmitter. Also, the lowest power level at which the alarm signal is received by the tracking module provides a direct indication of the distance between the security module 2 and the tracking module 10. This indication of distance can be communicated to the user of the tracking module by means of an audible and/or visual signal.

As the security module 2 is powered by a battery, the highest power level is transmitted less frequently than the lower levels in order to save power.

Once the security module 2 has been located, the radio beacon comprising the microcontroller 6 and antenna 8 can be deactivated to end the processes of FIGS. 2 and 3.

It will be appreciated by person skilled in the art that the above embodiment has been described by way of example only and not in any limitative sense, and that various alterations and modifications are possible without departure from the scope of the invention as defined by the appended claims. In particular, although the above embodiment has been described in connection with a cash cassette of an ATM, the security module 2 could be placed in any location at which valuables are stored in a portable container. Also, although the above embodiment has been described in connection with using radio frequency signals as a means of communication, other means of communication such as ultra sound could be used.

1-15. (canceled)

16. A security module comprising:
motion detector means adapted to detect motion of the security module relative to a cellular telephone network including a plurality of transceivers;
transmitter means for transmitting an alarm signal at a first duty cycle in response to detection by the motion detector means of motion of the security module relative to the cellular telephone network;
receiver means for receiving an acknowledgement signal transmitted by a tracking module; and
control means adapted to cause the transmitter means to transmit the alarm signal at a second duty cycle, greater than the first duty cycle, in response to receipt of the acknowledgement signal by the receiver means.

17. A module according to claim 16, wherein the control means is adapted to increase the duty cycle at which the alarm signal is transmitted in response to a further acknowledgement signal transmitted by the tracking module, the further acknowledgement signal indicating increased proximity between the security module and the tracking module.

18. A module according to claim 16, wherein the alarm signal is transmitted at a first plurality of power levels in response to detection by the motion detector means of motion of the security module relative to the cellular telephone network; and
the control means is adapted to cause the transmitter means to re-transmit the alarm signal at a second plurality of power levels comprising the lowest of the first plurality of power levels at which the alarm signal was received by the tracking module and at least one lower power level of the first plurality of power levels in response to receipt of the acknowledgement signal by the receiver means.

19. A module according to claim 18, wherein the control means is adapted to change the second plurality of power levels at which the alarm signal is transmitted in response to receipt of further acknowledgement signals by the receiver means to indicate the proximity of the tracking module to the security module.

20. A security module according to claim 18, wherein the alarm signal is transmitted more frequently at lower power levels than at higher power levels.

21. A security assembly comprising:
a tracking module for receiving an alarm signal transmitted by a security module and transmitting an acknowledgement signal in response to receipt of the alarm signal.

22. A security assembly according to claim 21, wherein the acknowledgement signal indicates a lowest of a first plurality of power levels at which the alarm signal was received by the tracking module.

23. A method of tracking a security module comprising:
transmitting an alarm signal at a first duty cycle by a security module in response to detection of motion of the security module relative to a cellular telephone network;
receiving an acknowledgement signal transmitted by a tracking module at the security module; and
wherein the security module transmits the alarm signal on a second duty cycle, greater than the first duty cycle, in response to receipt of the acknowledgement signal at the security module.

24. A method according to claim 23, further comprising increasing a duty cycle at which the alarm signal is transmitted in response to receipt of further acknowledgement signals at the security module, the further acknowledgement signals indicating increased proximity between the security module and the tracking module.

25. A method according to claim 23, wherein the alarm signal is transmitted at a first plurality of power levels in response to detection of motion of the security module relative to the cellular telephone network; and
further comprising re-transmitting the alarm signal at, a second plurality of power levels comprising a lowest of the first plurality of power levels at which the alarm signal was received by the tracking module and at least one lower power level of the first plurality of power levels in response to receipt of the acknowledgement signal by the security module.

26. A method according to claim 25, further comprising changing the second plurality of power levels at which the alarm signal is transmitted in response to receipt of further acknowledgement signals by the security module to indicate the proximity of the tracking module to the security module.

27. A method according to claim 26, wherein the alarm signal is transmitted more frequently at lower power levels than at higher power levels.
